(19) United States
(12) Patent Application Publication
(10) Pub. No.: US 2025/0081220 A1
(43) Pub. Date: Mar. 6, 2025

(54) DATA TRANSMISSIONS OVER AN ULTRA-RELIABLE LOW LATENCY COMMUNICATION (URLLC)

(71) Applicant: T-MOBILE INNOVATIONS LLC, Overland Park, KS (US)

(72) Inventors: Zheng CAI, Fairfax, VA (US); Zheng FANG, McLean, VA (US)

(21) Appl. No.: 18/459,094

(22) Filed: Aug. 31, 2023

(51) Int. Cl. H04W 72/512; H04W 72/54

(52) U.S. Cl. CPC H04W 72/512; H04W 72/54; H04W 84/06

(57) ABSTRACT

The technology disclosed herein relates to improved data transmissions over a radio access network (RAN). In embodiments, the RAN can receive, via a RAN node, a request for extended reality (XR) traffic (e.g., the request being associated with a user device). In embodiments, based on the request, one or more components of the RAN can allocate XR data for transmission over one or more ultra-reliable low latency communication (URLLC) slices that each have a latency parameter below an XR latency threshold. In embodiments, the XR latency threshold can be determined based on the request. In embodiments, one or more RAN components can identify a frequency band (e.g., associated with a RAN node) having a URLLC slice that has a latency parameter below the XR latency threshold. As such, XR data can be transmitted to the user device via the URLLC slice having the latency parameter below the XR latency threshold.

### SUMMARY

This summary provides a high-level overview of various aspects of the technology disclosed herein, and the detailed-description section below provides further description herein. This summary is not intended to identify key features or essential features of the claimed subject matter, nor is it intended to be used as an aid in isolation to determine the scope of the claimed subject matter. The present disclosure is directed, in part, to technology associated with improved data transmissions over a radio access network (RAN), substantially as shown in and/or described in connection with at least one of the figures, and as set forth more completely in the claims.

In aspects set forth herein, and at a high level, embodiments of the technology described herein may include one or more transmissions (e.g., of extended reality (XR) data) over one or more ultra-reliable low latency communication (URLLC) slices based on one or more of an XR latency threshold, a data rate threshold, a jitter threshold, another type of URLLC parameter threshold, or one or more combinations thereof. For example, a network (or one or more portions thereof), having one or more RAN nodes, may identify a frequency band having one or more URLLC slices that has a latency parameter (or data rate, jitter, or another type of URLLC parameter) below a threshold. In embodiments, the one or more URLLC slices can be identified based on a request received from a user device (e.g., a request for XR traffic). Based on receiving the request and identifying the one or more URLLC slices, the network can transmit one or more XR data packets to the user device over one or more of the URLLC slices.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, wherein:

FIGS. 1A-1B depict an example operating environment for improved data transmissions over a radio access network (RAN), in accordance with aspects herein;

FIG. 2 illustrates an example flowchart for improved data transmissions over the RAN from the network perspective, in accordance with aspects herein;

FIG. 3 illustrates an example flowchart for improved data transmissions over the RAN from the user device perspective, in accordance with aspects herein;

FIG. 4 depicts an example satellite suitable for use in implementations of the present disclosure, in accordance with aspects herein; and

FIG. 5 depicts an example user device suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Cellular Communication System
4G Fourth-Generation Cellular Communication System
5G Fifth-Generation Cellular Communication System
AR Augmented Reality
ARFCN Absolute Radio Frequency Channel
CD-ROM Compact Disk Read Only Memory
CDMA Code Division Multiple Access
E2E End-to-End
eMBB enhanced Mobile Broadband
eNB Evolved Node B
gNB Next Generation Node B
GPRS General Packet Radio Service
GSM Global System for Mobile communications
DVD Digital Versatile Discs
EEPROM Electrically Erasable Programmable Read Only Memory
E-UTRA Evolved Universal Terrestrial Radio Access
FD-MIMO Full-Dimension Multiple-Input Multiple-Output
GPS Global Positioning System
IoT Internet of Things
LAN Local Area Network
LTE Long Term Evolution
MIMO Multiple-Input Multiple-Output
mm wave Millimeter wave
MME Mobility Management Entity
MU-MIMO Multi-User Multiple-Input Multiple-Output
NR New Radio
PC Personal Computer
PDA Personal Digital Assistant
RAM Random Access Memory
RAN Radio Access Network
RCPP Radio Channel Performance Predictor
RF Radio-Frequency
RIC RAN Intelligent Controller
ROM Read Only Memory
RSRP Reference Signal Received Power
RSRQ Reference Transmission Receive Quality
RSSI Received Signal Strength Indicator
SNR Signal-to-Noise Ratio
SRS Sound Reference Signal
TDMA Time Division Multiple Access
UPF User Plane Function
URLLC Ultra-Reliable Low Latency Communication
vCU Virtual Centralized Unit
vDU Virtual Distributed Unit
VLAN Virtual Local Area Network
VR Virtual Reality
XR eXtended Reality

In addition, words such as “a” and “an,” unless otherwise indicated to the contrary, may also include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

Further, the term “some” may refer to “one or more.” Additionally, an element in the singular may refer to “one or more.” The term “plurality” may refer to “more than one.”

The term “combination” (e.g., one or more combinations thereof) may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

As used herein, the phrase “based on” shall be construed as a reference to an open set of conditions. For example, an example step that is described as “based on X” may be based on both X and additional conditions, without departing from the scope of the present disclosure. In other words, as used herein, the phrase “based on” shall be construed in the same manner as the phrase “based at least in part on.”

The term “mm wave,” as used herein, may refer to the extremely high frequency band (e.g., from 30 GHz to 300 GHz). Additionally or alternatively, in some embodiments, a millimeter wave transmission may include one or more frequency ranges of 24 GHz, 26 GHz, 28 GHz, 39 GHz, and 52.6-71 GHz.

The term “XR” refers to “extended reality,” and may include technologies such as virtual reality, augmented reality, mixed reality, XR gaming, another type of computer-implemented environment, or one or more combinations thereof.

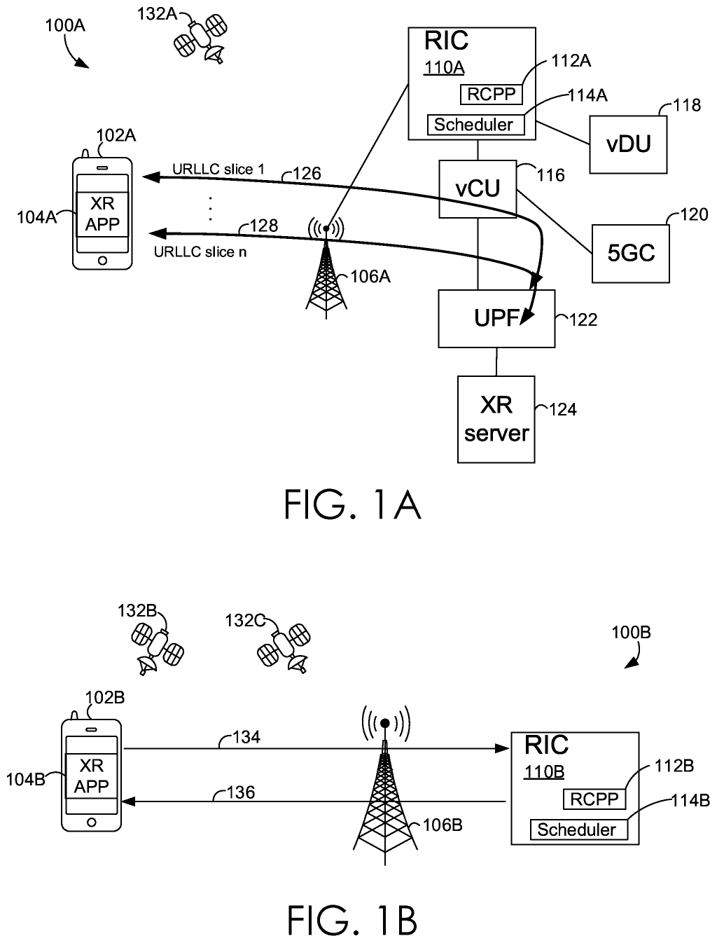

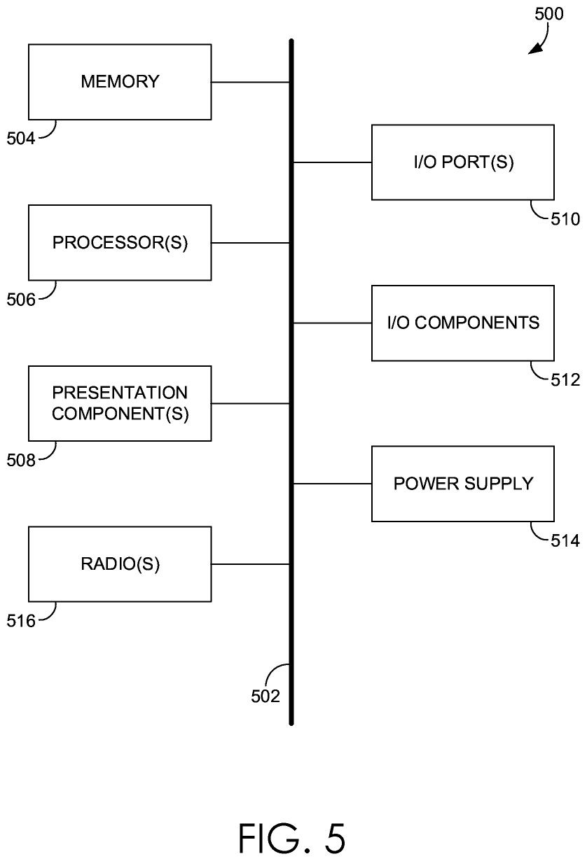

Additionally, a “user device,” as used herein, is a device that has the capability of transmitting or receiving one or more signals to or from a RAN node, and may also be referred to as a “computing device,” “mobile device,” “user equipment,” “client device,” “wireless communication device,” or “UE.” A user device, in some embodiments, may take on a variety of forms, such as a PC, a laptop computer, a tablet, an IoT device (e.g., a sensor, controller (e.g., a lighting controller, a thermostat), appliance (e.g., a smart refrigerator, a smart air conditioner, a smart alarm system)), a wearable device (e.g., a watch-type electronic device, a glasses-type wearable device), a mobile phone, a PDA, a server, another type of device that is capable of communicating with other devices (e.g., by transmitting or receiving a signal), or one or more combinations thereof. In some embodiments, the user device is associated with a vehicle (e.g., a video system in a car capable of receiving media content stored by a media device in a house when coupled to the media device via a local area network). In some embodiments, the user device comprises a medical device, a location monitor, a clock, other wireless communication devices, or one or more combinations thereof. A user device may be, in some embodiments, user device 102A or 102B described herein with respect to FIGS. 1A-1B or user device 500 described herein with respect to FIG. 5.

A “wireless telecommunication service” refers to the transfer of information without the use of an electrical conductor as the transferring medium. Wireless telecommunication services may be provided by one or more telecommunication network providers. Wireless telecommunication services may include, but are not limited to, the transfer of information via radio waves (e.g., Bluetooth®), satellite communication, infrared communication, microwave communication, Wi-Fi, mm wave communication, and mobile communication. Embodiments of the present technology may be used with different wireless telecommunication technologies or standards, including, but not limited to, CDMA 1×Advanced, GPRS, EV-DO, TDMA, GSM, WiMAX technology, LTE, LTE Advanced, 5G, other technologies and standards, or one or more combinations thereof.

A “network” can provide one or more wireless telecommunication services and may transmit or receive a wireless signal to or from a user device. In embodiments, a network may be one or more telecommunications networks, or a portion thereof. The network might include an array of devices or components (e.g., one or more base stations). Additionally or alternatively, the network can include multiple networks, and the network can be a network of networks. In embodiments, the network or a portion thereof may be a core network, such as an evolved packet core or 5G core, which may include a control plane entity (e.g., a mobility management entity), a user plane entity (e.g., a serving gateway), and an access and mobility management function. In some embodiments, the network may comprise one or more public or private networks—wherein one or more of which may be configured as a satellite network (e.g., a 3GPP non-terrestrial network), a publicly switched telephony network, a cellular telecommunications network, another type of network, or one or more combinations thereof.

In embodiments, the network may comprise the satellite network connecting one or more gateways (e.g., a device or a system of components configured to provide an interface between the network and a satellite) to other networks, a cellular core network (e.g., a 4G, 5G, of 6G core network, an IMS network, and the like), a data network, another type of network, or one or more combinations thereof. In such embodiments, each of the satellite network and the cellular core network may be associated with a network identifier, such as a public land mobile network, a mobile country code, a mobile network code, or the like, wherein the network identifier associated with the satellite network is the same or different than the network identifier associated with the cellular network.

In embodiments, the network (including the satellite network) can connect one or more user devices to a service provider for services such as 5G and LTE, for example. In aspects, a service provided to a user device may comprise one or more of a voice service, a message service (e.g., SMS messages, MMS messages, instant messaging messages, an EMS service messages), a data service, an XR application service, other types of wireless telecommunication services, or one or more combinations thereof. The network can comprise any communication network providing voice, message, or data service(s), such as, for example, a 1× circuit voice, a 3G network (e.g., CDMA, CDMA2000, WCDMA, GSM, UMTS), a 4G network (WiMAX, LTE, HSDPA), a 5G network, a 6G network, another generation network, or one or more combinations thereof. Components of the network, for example, may include terminals, links, gateways, nodes (e.g., a core network node), relay devices, integrated access and backhaul nodes, other types of network components, or one or more combinations thereof.

As used herein, the term “base station” refers to a centralized component or system of components configured to wirelessly communicate (e.g., receive and/or transmit signals) with various devices or components (e.g., a user device, a relay device) in a particular geographical area. A base station may be referred to as one or more cell sites, nodes, gateways, remote radio unit control components, base transceiver stations, access points, NodeBs, eNBs, gNBs, Home NodeBs, Home eNodeBs, macro base stations, small cells, femtocells, relay base stations, another type of base station, or one or more combinations thereof. A base station may be, in an embodiment, similar to base station 106B described herein with respect to FIG. 1B.

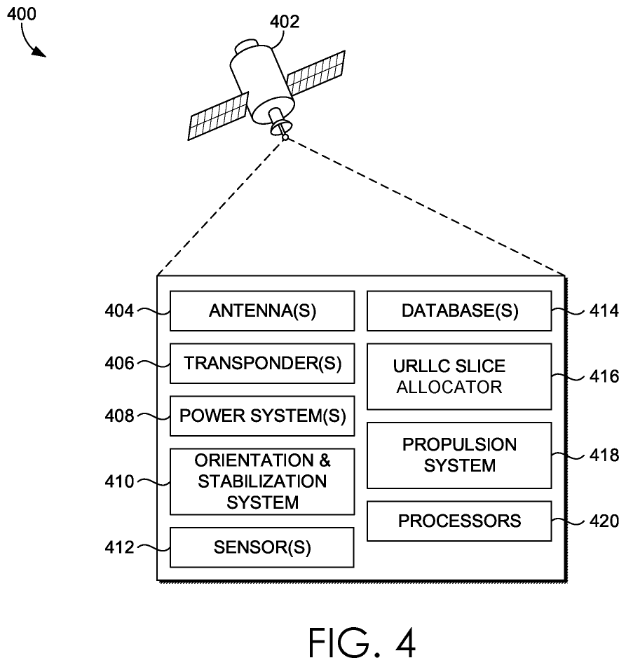

The term “satellite,” as used herein, is an extraterrestrial base station that is distinguished from a terrestrial base station on the basis of its lack of ground coupling. Some examples of a satellite can include a space satellite, a balloon, a dirigible, an airplane, a drone, an unmanned aerial vehicle, a geosynchronous or geostationary earth orbit satellite, a low earth orbit satellite, a medium earth orbit satellite, a bent-pipe satellite, a regenerative satellite, another type of satellite, or one or more combinations thereof. A satellite may be, in an embodiment, similar to satellites 132A, 132B and 132C described herein with respect to FIGS. 1A-1B or similar to satellite 402 described herein with respect to FIG. 4.

Embodiments of the technology described herein may be embodied as, among other things, a method, system, or computer-program product. Accordingly, the embodiments may take the form of a hardware embodiment, or an embodiment combining software and hardware. An embodiment that takes the form of a computer-program product can include computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal (e.g., a modulated data signal referring to a propagated signal that has one or more of its characteristics set or changed to encode information in the signal). Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, XR is a growing field within wireless communication technologies. XR applications, including dynamic reconstruction of 3D environments or fusions of real world environments and virtual environments, utilize high quality video or high quality audio data communications with low latency. For example, XR applications can be used for gaming, simulation training, architectural visualization, entertainment, interactive experiences, therapy, surgical simulations, virtual events, design visualization, other types of user-related experiences, or one or more combinations thereof. As another example, XR applications can utilize XR data for employing head mounted displays, heads-up displays, eyeglasses, other types of wearable devices, or one or more combinations thereof. Enhanced Mobile Broadband (eMBB) is generally characterized as a wireless telecommunication service category that provides enhanced data rates and reliability, especially when compared with prior generations of wireless service. With respect to XR applications, eMBB can deliver high data rates and increased capacity to meet the high data demands of XR applications and other XR experiences for users. For example, XR data corresponding to an XR application can be generated and compressed for transmission over a 5G eMBB network. Additionally, XR applications can transmit real-time XR data (e.g., in a virtual reality gaming application or another type of collaborative reality application) over the 5G eMBB network for real-time virtual interactions between or among users.

Unlike eMBB, URLLC is a service category designed to support applications having extremely low latency and ultra-high reliability requirements. Whereas eMBB latency requirements are generally within the range of a few milliseconds to tens of milliseconds, URLLC latency requirements can range from a few milliseconds and lower. XR data has not conventionally been transmitted using URLLC, at least because one problem with transmitting XR data via URLLC is that URLLC utilizes lower bandwidth for the transmission of smaller data packets, whereas eMBB utilizes higher bandwidth for transmissions of larger data packets at higher volumes. Modern bases stations are capable of communicating using both eMBB and URLLC, and can use network slicing techniques to partition and provide wireless service to user devices as desired by a mobile network operator.

Aspects of the present disclosure are directed to implementing URLLC slicing techniques for transmitting XR data from a RAN to a UE for lower latency and higher reliability than conventional methods. In this way, UEs can achieve more successful, faster, and more robust data transmissions corresponding to XR data (e.g., for an XR application). Furthermore, the technology disclosed herein can improve communications between or among user devices (and/or other devices) by improving both the quality of service and user experience. In this way, the technology and corresponding techniques disclosed herein can enhance the reliability and functionality of communications.

In an embodiment, a system is provided for improved data transmissions over a RAN. The system comprises one or more RAN nodes, one or more processors associated with the one or more RAN nodes, and computer memory storing computer-usable instructions that, when executed by the one or more processors, cause the system to perform operations. The operations comprise receiving a request for extended reality (XR) traffic, the request being associated with a user device. Based on the request, the operations further comprise identifying a frequency band associated with the one or more RAN nodes, the frequency band having an ultra-reliable low latency communication (URLLC) slice that has a latency parameter below an XR latency threshold. The operations also comprise transmitting an XR data packet, via the URLLC slice having the latency parameter below the XR latency threshold, to the user device.

In another embodiment, a method for improved data transmissions over a RAN is provided. The method comprises receiving, via a RAN node, a request for extended reality (XR) traffic, the request being associated with a user device. Based on the request, the method further comprises allocating a plurality of XR data packets for transmission over one or more ultra-reliable low latency communication (URLLC) slices, and identifying a frequency band associated with the RAN node, the frequency band having a URLLC slice, corresponding to the one or more URLLC slices, that has a latency parameter below an XR latency threshold. The method further comprises transmitting a first XR data packet, of the plurality of XR data packets, to the user device via the URLLC slice having the latency parameter below the XR latency threshold.

Another embodiment includes one or more non-transitory computer storage media having computer-executable instructions embodied thereon, that when executed by at least one processor, cause the at least one processor to perform a method. The method comprises transmitting, via a user device, a request for extended reality (XR) traffic. Based on the request, the method further comprises receiving an XR data packet, from an ultra-reliable low latency communication (URLLC) slice having a latency parameter below an XR latency threshold, and receiving a second XR data packet from a second URLLC slice having a latency parameter below the XR latency threshold.

Turning now to FIG. 1A, example operating environment 100A is illustrated in accordance with one or more embodiments disclosed herein. At a high level, the example operating environment 100A comprises user device 102A having an XR application 104A. Further, a radio 106A, satellite 132A, and RIC 110A including RCPP 112A and scheduler 114A. The RIC 110A in example operating environment 100A is communicatively coupled to vCU 116, vDU 118, core network signaling 120 via the vCU 116, UPF 122 (associated with a plurality of URLLC slices including URLLC slice₁ 126 and URLLC sliceₐ 128) via the vCU 116, and XR server 124 via the UPF 122.

Example operating environment 100A is but one example of a suitable environment for the technology and techniques disclosed herein, and is not intended to suggest any limitation as to the scope of use or functionality of the invention. Neither should the environment 100A be interpreted as having any dependency or requirement relating to any one or combination of components illustrated. For example, other embodiments of example operating environment 100A may have more or less user devices, base stations, satellites, or other RAN components (e.g., another XR server). As another example, even though the user device 102A is illustrated in example operating environment 100A as a mobile phone, the user device 102A may also be another type of user device (e.g., a tablet, a wearable device). In yet another example, even though the satellite 132A is illustrated in example operating environment 100A as a satellite vehicle, the satellite 132A may also be another type of satellite (e.g., a balloon or high-altitude platform station, a dirigible, an airplane, a drone, an unmanned aerial vehicle).

User device 102A may be configured to wirelessly communicate (e.g., by transmitting or receiving one or more signals) with one or more radios (e.g., radio 106A, which may be a DU or CU), one or more satellites (e.g., satellite 132A), other types of wireless telecommunication devices (e.g., XR server 124), or one or more combinations thereof. User device 102A may be an XR capable device having one or more XR applications (e.g., XR application 104A) downloaded onto the XR capable device. As an example, the XR application 104A may correspond to entertainment, gaming, healthcare, manufacturing, engineering, food production, e-commerce, retail, travel, education, meetings, training, or another type of XR application. In an embodiment, an XR interface between the XR application 104A and XR runtime (e.g., XR functionality including a frame composition, user action triggered by the XR capable device, tracking information, another type of XR functionality, or one or more combinations thereof) includes a layered API (e.g., the OpenXR interface).

In some embodiments, the user device 102A may be one or more haptic gloves for XR interactions, a head-mounted display device (e.g., Oculus™, GearVR, Rift™, MagicLeap™) another type of head-mounted device, another type of XR device, or one or more combinations thereof. In embodiments, user device 102A may include one or more of a unit, a station, a terminal, or a client, for example. In some embodiments, the user device 102A may act as a relay. In some embodiments, the user device 102A may be a wireless local loop station, an IoT device, an Internet of Everything device, a machine type communication device, an evolved or enhanced machine type communication device, another type of user device, or one or more combinations thereof. In some embodiments, a plurality of user devices having the XR application 104A or a plurality of XR servers (e.g., including XR server 124) may participate in an XR split rendering session (e.g., the XR server 124 may stream media data to user device 102A using a streaming network protocol).

In embodiments, the radio 106A can be in different forms or can have different capabilities. For example, even though the radio 106A is illustrated in example operating environment 100A as a macro base station, the radio 106A may be another type of base station (e.g., a gateway node, such as a satellite dish), a DU, or a CU. Further, the radio 106A may perform one or more of the following functions: transfer user data, radio channel ciphering, radio channel deciphering, integrity protection, header compression, mobility control functions (e.g., handover, dual connectivity), inter-cell interference coordination, connection setup and release, load balancing, distribution for non-access stratum messages, non-access stratum node selection, synchronization, RAN sharing, multimedia broadcast multicast service, subscriber and equipment trace, RAN information management, paging, positioning, delivery of a warning message, another type of base station functionality, or one or more combinations thereof. The radio 106A can provide communication coverage for a particular geographic coverage area in which the user device 102A is located in. In 3GPP, the term “cell” can refer to this particular geographic coverage area or a base station subsystem serving one or more portions of the particular geographic coverage area. In some embodiments, the radio 106A is a macro cell (e.g., having several kilometers in radius), a small cell (e.g., a pico cell, a femto cell), another type of cell, or one or more combinations thereof. In some embodiments, the small cell is a home node or a portable access point. In some embodiments, the radio 106A utilizes MIMO capabilities for 3D beamforming (e.g., in both elevation and azimuth beamforming).

In some embodiments, the radio 106A may communicate directly or indirectly (e.g., through Trans-European Transport Network or core network 120) with another base station over a backhaul link (e.g., using an X2 interface), which may be wired or wireless. In embodiments, one or more communication links (e.g., a feeder link) can connect one or more of the satellites (e.g., satellite 132A) with other network nodes. In other embodiments, the satellite 132A can connect to a base station. In some embodiments, the satellite 132A can connect to another network component via a network node embarked onboard the satellite 132A. For example, in embodiments wherein the satellite 132A has the one or more network nodes embarked onboard, the network node can connect to the user device 102A via a service link using a Uu interface. In yet another example, the satellite 132A may have one or more access nodes, such as one or more gNB components (e.g., a gNB distributed unit) onboard the satellite 132A. As such, the user device 102A can transmit or receive signals to or from the satellite 132A.

In example operating environment 100A, the RIC 110A is communicatively coupled to the vCU 116 and the vDU 118. The vDU 118 can be configured to perform signal processing, user device scheduling, other types of distributed unit functionality, or one or more combinations thereof. In some embodiments, the vDU 118 can host one or more of a radio link control layer, a medium access control layer, a high physical layer, a low physical layer (e.g., implemented by one or more modules for a fast Fourier transform, an inverse fast Fourier transform, digital beamforming, or physical random access channel extraction and filtering), or one or more combinations thereof. In embodiments, each of these one or more layers can be implemented with an interface configured to communicate signals with another layer hosted by the vDU 118. In some embodiments, the vCU 116 can host one or more higher layer control functions (e.g., a radio resource control function, a packet data convergence protocol function, a service data adaptation protocol function). In embodiments, a control function hosted by the vCU 116 can be implemented with an interface that communicates signals with another control function hosted by the vCU 116.

In some embodiments, the RIC 110A can be communicatively coupled with the core network 120 (e.g., via the vCU 116). For example, a portion of network may be a core network, such as the core network 120 (e.g., a 5G core, evolved packet core network, or the like), which may include a control plane entity (e.g., a mobility management entity), a user plane entity (e.g., a serving gateway), or an access and mobility management function. The core network 120 can include an evolved packet core, for example. In some embodiments, the core network 120 may be one or more public land mobile networks located in one or more countries. In some embodiments, the core network 120 may comprise one or more public or private networks. In some embodiments, the core network 120 may be associated with a network identifier, such as a public land mobile network, a mobile country code, a mobile network code, or the like, wherein the network identifier associated with the satellite network associated with satellite 132A is the same or different than the network identifier associated with the cellular network.

In some embodiments, the RIC 110A can be communicatively coupled with the UPF 122 (e.g., via the vCU 116). In embodiments, the UPF 122 may perform functions, such as, for example, XR data packet routing, XR data packet forwarding, XR data packet inspection, XR traffic usage reporting, quality of service handling associated with XR applications or other XR traffic usage, transport level XR data packet marking, downlink packet buffering, traffic verification, downlink XR data notification triggering, other types of UPF functionality, or one or more combinations thereof. In embodiments, one or more functionalities of the UPF 122 may be supported in one or more URLLC slices. In some embodiments, the UPF 122 is virtually implemented in software. In some embodiments, the network supports techniques for modifying an XR data session of the user device 102A by changing the UPFs that serves the XR data session.

In some embodiments, the RIC 110A can be communicatively coupled with the XR server 124 (e.g., via the UPF 122). In some embodiments, the user device 102A communicates with the XR server 124 via an XR user interface (e.g., for selecting an XR experience for a user to interact with the XR server 124). The XR server 124 can support one or more XR experiences for a user. In some embodiments, the XR server 124 can support enhancement of XR experiences for the user. In some embodiments, the XR server 124 and user device 102A communicate over a Wi-Fi reverse direction grant mode link. In some embodiments, the XR server 124 performs one or more control functions related to the XR application 104A and an XR service. For example, the XR server 124 may handle frame rendering for a head-mounted display user device (e.g., user device 102A) that detects pose tracking. In some embodiments, the XR server 124 can generate a compressed rendered video buffer or a compressed rendered audio buffer for the user device 102A to decompress for display via the user device 102A. In some embodiments, the XR server comprises or is communicatively coupled to one or more databases storing haptic data, object data, pose data, frame data, or other types of XR data.

In some embodiments, the XR server 124 can support one or more of the examples XR applications in the table below:

TABLE 1

| Application | Data Type | Latency | | Service Area | | Description |
|---|---|---|---|---|---|---|
| Virtual Reality | | | | | | |
| | 360 VR Video | 20~40 | ms | | | 4K (3845 × 2160), 60 FPS, 20~40 Mbps |
| | | 90~130 | ms | | | 8K (7680 × 4320), 90 FPS, 90~130 Mbps |
| | | ~10 | ms | | | 12K 3D (11520 × 6480), 120 FPS, 500~700 |
| | | | | | | Mbps |
| | CG VR Video | ~20 | ms | | | 2K (2560 × 1440), 70 FPS, 30~50 Mbps |
| | | ~16 | ms | | | 4K (3840 × 1920), 90 FPS, 50~200 Mbps |
| | | ~10 | ms | | | 8K (7680 × 3840), 120 FPS, 200~800 Mbps |
| Vehicle-to- | | 3~10 ms | | few meters | | |
| Everything | | (E2E) | | | | |
| (V2X) | | | | | | |
| | Remote Driving | 5 ms | | | | 1 Mbps/DL, 20 Mbps/UL, speed ~250 |
| | | (E2E) | | | | km/h |
| | Collective | 3 ms | | 200 | m | Exchange of real-time information among |
| | Perception | (E2E) | | | | vehicles |
| | | 10 ms | | 500 | m | |
| | | (E2E) | | | | |
| | | 50 ms | | 1000 | m | |
| | | (E2E) | | | | |
| Industrial | | | | | | |
| Automation | | | | | | |

| | | |
|---|---|---|
| Motion Control | 0.5~2 ms | |
| | (E2E) | |
| Discrete | 10 ms | ~10 Mbps |
| Automation | (E2E) | |

In example environment 100A, a radio, satellite 132A, or one or more combinations thereof, can provide one or more services (e.g., for Internet browsing, a Wi-Fi messaging service, Voice over IP, gaming, High Frequency Trading, SMS messaging, MMS messaging) to the user device 102A. For example, components of the network can provide XR data to XR application 104A and can receive data from the XR application 104A. As another example, the network can support communications between the user device 102A and the XR server 124.

In embodiments, the network can support the receipt (e.g., by the XR server 124, by the UPF 122) of one or more requests (e.g., for XR traffic) associated with user device 102A (e.g., the one or more requests being transmitted by the XR application 104A of the user device 102A). In some embodiments, the XR application 104A utilizes multiple simultaneous data flows having one or more quality of service requirements (e.g., a particular latency range corresponding to an XR latency threshold, one or more XR latency thresholds). In some embodiments, the request for XR traffic may correspond to downlink traffic. In addition, in some embodiments, the request for the XR traffic may include an XR traffic periodicity range, an XR traffic file distribution size, a downlink data rate, a maximum packet delay, a maximum round trip time, another XR traffic characteristic, or one or more combinations thereof. In some embodiments, the XR traffic request is associated with delivering or decoding an XR object (e.g., an avatar).

In a non-limiting example based on Table 1 above, the request for XR traffic may correspond to XR video data for a VR application having a twenty to forty millisecond latency requirement for providing 4 k resolution, 60 frames per second, and about 20-40 megabits per second. As another non-limiting example from Table 1, the request for XR traffic may correspond to XR video data for a VR application having a ten millisecond latency requirement for providing 12 k resolution, 120 frames per second, and about 500-700 megabits per second. In yet another example from Table 1, the request for XR traffic may correspond to vehicle-to-everything data for a vehicle-to-everything application having a three millisecond latency requirement for providing a collective perception for a 200 meter service area and for the exchange of real-time information between or among vehicles. In yet another example, the request for XR traffic may correspond to vehicle-to-everything data for a vehicle-to-everything application having a five millisecond latency requirement for remote driving with one megabit per second downlink communications and twenty megabits per second uplink communications.

Based on the request for XR traffic, system can identify a frequency band that is associated with one or more RAN nodes (e.g., satellite 132A) and that has a URLLC slice associated with a particular XR-based threshold (e.g., some frequencies may not have support for URLLC slicing, so in order for the system to better support requests for XR traffic, the RIC, for example, will need to identify one or more frequency bands that are suitable for fulfilling the XR requests and scheduling traffic based on at least one of said frequency bands). As an example, the frequency band can be identified based on the URLLC slice having a latency parameter below an XR latency threshold. In some embodiments, the frequency band can be identified based on the URLLC slice having a maximum round trip time below a maximum round trip time threshold. In some embodiments, the frequency band can be identified based on the URLLC slice having a jitter measurement below an XR jitter threshold. In some embodiments, the frequency band can be identified based on the URLLC slice having a user experienced data rate above a user experienced data rate threshold. In some embodiments, the frequency band can be identified based on the URLLC slice having a payload size within an XR payload size range. As another example with reference to Table 1, the URLLC slice can be identified for XR traffic including a vehicle-to-everything data for a vehicle-to-everything application, wherein the URLLC slice is identified based on having an XR latency parameter below a five millisecond latency threshold (e.g., for remote driving and for XR traffic corresponding to one megabit per second downlink communications and twenty megabits per second uplink communications).

In some embodiments, the user device 102A can dynamically select one or more URLLC slices for the transmission of or receipt of XR data based on information provided by the RCPP 112A of the RIC 110A. For example, the RCPP 112A (e.g., an application running on the RIC 110A) can provide one or more user devices (e.g., user device 102A) with one or more URLLC slice performance measurements (e.g., a latency parameter, a jitter measurement, a communication service availability, a reliability, a user experienced data rate, a payload size, loading/congestion, a packet loss rate, a packet loss ratio, an average throughput, a packet delay) for one or more URLLC slices corresponding to one or more frequency bands, such that the user device 102A can dynamically select one or more URLLC slices for the transmission of or receipt of XR data associated with the request for XR traffic. As a non-limiting example, based on receiving the URLLC slice performance measurements from the RCPP 112A, user device 102A can be assigned a first URLLC slice (e.g., based on the first URLLC slice having an XR latency parameter below a five millisecond latency threshold) for the transmission of or receipt of XR data (e.g., for vehicle-to-everything traffic corresponding to one megabit per second downlink communications and twenty megabits per second uplink communications), and a second URLLC slice (e.g., based on the second URLLC slice having an XR latency parameter below a ten millisecond end-to-end latency threshold) for the transmission of or receipt of XR data (e.g., for discrete automation traffic corresponding to ten megabits communications).

Based on the one or more URLLC slice performance measurements provided by the RCPP 112A, the user device can request one or more particular URLLC slices (e.g., a URLLC slice meeting XR application requirements (e.g., of XR application 104A)). Based on the request for the one or more particular URLLC slices, the RAN can accept this request and transmit XR data (e.g., one or more XR data packets via at least in part through the UPF 122) to the user device 102A via the URLLC slice having the latency parameter below the XR latency threshold (e.g., via one or more of URLLC slice₁ 126 or URLLC sliceₙ 128). In some embodiments, system transmits a first XR data packet to the user device 102A via the URLLC slice₁ 126 based at least in part on utilizing the UPF 122, a second XR data packet to the user device 102A via another URLLC slice (e.g., URLLC slice₂) based at least in part on utilizing the UPF 122, and a third XR data packet to the user device 102A via the URLLC sliceₙ 128 based at least in part on utilizing the UPF 122. In some embodiments, each of the XR data packets transmitted to the user device 102A are below a threshold packet size. Further, in some embodiments, the scheduler 114A (e.g., a centralized scheduler within the RIC 110A of a cloud-based RAN) can transmit over a New Radio Absolute Radio Frequency Channel Number corresponding to each URLLC slice to the user device 102A.

Turning now to FIG. 1B, example operating environment 100B is illustrated in accordance with one or more embodiments disclosed herein. The example operating environment 100B comprises user device 102B having an XR application 104B (e.g., the same XR application as XR application 104A or a different XR application), base station 106B, RIC 110B including RCPP 112B (e.g., an application running on the RIC 110B) and scheduler 114B (e.g., a centralized scheduler within the RIC 110B of a cloud-based RAN, a scheduler that applies reinforcement learning and neural networks for scheduling decisions), satellites 132B and 132C (e.g., satellite 132B directly communicating with user device 102B and satellite 132C, and satellite 132C utilizing base station 106B as a gateway to the RAN), radio channel performance request 134, and response report 136.

Example operating environment 100B is but one example of a suitable environment for the technology and techniques disclosed herein, and is not intended to suggest any limitation as to the scope of use or functionality of the invention. For example, other embodiments of example operating environment 100B may have satellite 132B interfacing with the terrestrial RAN via the base station 106B. As another example, other embodiments of example operating environment 100B may have the scheduler 114B software integrated into another platform of the RAN within the example operating environment 100B.

In embodiments, user device 102B can transmit a request for XR traffic to the RIC 110B via the radio channel performance request 134. Based on receiving the request for XR traffic, the RCPP 112B can determine one or more of a latency parameter, a jitter measurement, a communication service availability, a reliability, a user experienced data rate, a payload size, loading/congestion, a packet loss rate, a packet loss ratio, an average throughput, packet delay, another type of URLLC slice performance measurement, or one or more combinations thereof, for one or more URLLC slices (e.g., provided by the base station 106B, satellite 132B, or satellite 132C) associated with a frequency band. Based on determining the URLLC slice performance measurement and the request for XR traffic (e.g., corresponding to XR application 104B), the RIC 110B can communicate the URLLC slice performance measurement (e.g., the data rate, the latency parameter, the jitter measurement) to the user device 102B (e.g., via the response report 136). In response to receiving the URLLC slice performance measurement from the RIC 110B, the user device 102B can dynamically select one or more URLLC slices (e.g., of a plurality of URLLC slices provided by base station 106B, satellite 132B, or satellite 132C) for the transmission of or receipt of XR data. Further, in embodiments, the user device 102B can request (e.g., via the radio channel request 134) the selected one or more URLLC slices, and the RAN can provide the XR traffic to the user device 102B via the selected one or more URLLC slices.

### Example Flowcharts

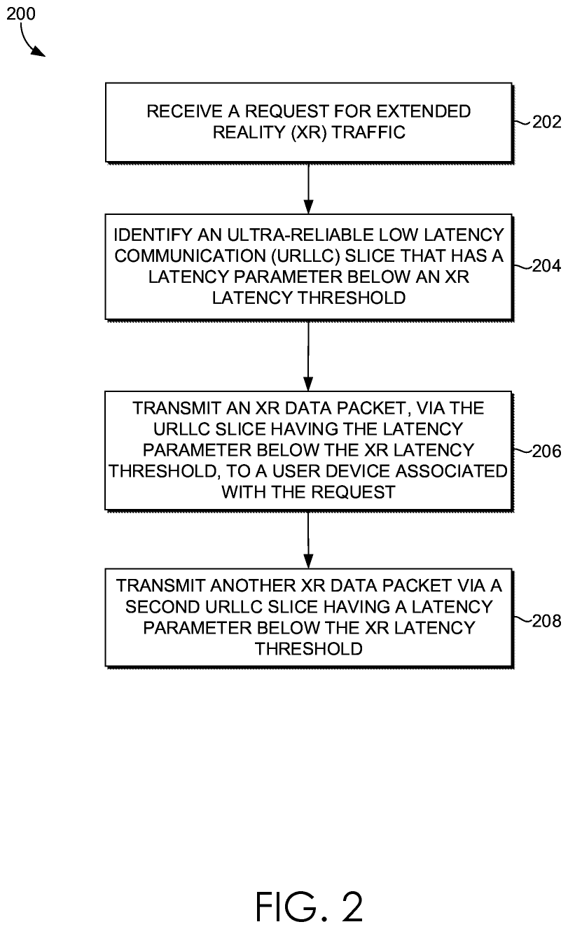

Having described the example embodiments discussed above, an example flowchart from the network perspective is described below with respect to FIG. 2. Example flowchart 200 begins at 202 with receiving a request for XR traffic. In some embodiments, the request for XR traffic may be associated with a user device. For example, the XR traffic may correspond to an XR application or cloud gaming that utilizes multiple simultaneous data flows having one or more quality of service requirements (e.g., a particular latency range). Further, in some embodiments, the XR traffic may correspond to downlink traffic, uplink traffic (e.g., XR viewer pose data), another type of traffic, or one or more combinations thereof. In addition, in some embodiments, the request for the XR traffic may include an XR traffic periodicity range corresponding to an almost constant periodicity range, an almost constant with a peek during start-up, another periodicity range, or one or more combinations thereof. In some embodiments, the request for XR traffic may include a downlink data rate range, an uplink data rate range, a maximum packet delay (e.g., for uplink, downlink, or both), a maximum packet error rate, a maximum round trip time, another XR traffic characteristic, or one or more combinations thereof. In some embodiments, the XR traffic request is associated with combining, delivering, decoding, or rendering an XR object (e.g., an avatar, sound source, live streaming content) into a single user experience.

At 204, the method includes identifying a URLLC slice that has a latency parameter below a XR latency threshold. In some embodiments, the XR latency threshold is included in the request for XR traffic. In some embodiments, a frequency band (e.g., associated with the one or more RAN nodes, such as a base station or satellite, for example) can be identified, wherein the frequency band includes the URLLC slice with the latency parameter below the XR latency threshold. Further, the RAN may be capable of configuring a plurality of network slices (e.g., URLCC slices associated with a logical network supporting network functions that implement network resources) to support a plurality of XR traffic. In embodiments, one or more of the URLCC slices can include user plane functionality, user plane resources, another type of resource or functionality, or one or more combinations thereof. In some embodiments, one or more of the URLLC slices can be configured for a remote control operation use scenario (e.g., for a medical or industrial environment), a robotics or automation use scenario, another type of mobile critical-infrastructure low-latency use scenario, or one or more combinations thereof. In some embodiments, the frequency band having the URLLC slice with the latency parameter below the XR latency threshold may be transmitted by a small cell.

In some embodiments, a first URLLC slice having a latency parameter below the XR latency threshold is identified and a second URLLC slice having a latency parameter below the XR latency threshold is identified, wherein the first URLLC slice and the second URLLC slice correspond to different frequency channels on the same frequency band. In other embodiments, the first URLLC slice and the second URLLC slice correspond to different frequency channels on different frequency bands. In some embodiments, the first URLLC slice and the second URLLC slice are provided by the same RAN node (e.g., via one or more antenna arrays or elements of a base station). In other embodiments, the first URLLC slice and the second URLLC slice are provided by different RAN nodes. For example, in some embodiments, the first URLLC slice is provided by a first base station and the second URLLC slice is provided by a second base station. As another example, the first URLLC slice may be provided by a small cell and the second URLLC slice may be provided by a satellite. Further, in some example embodiments, the XR latency threshold may be less than 20 milliseconds motion-to-photon latency or may correspond to another time-based latency threshold. In other embodiments, the XR latency threshold corresponds to an inertial measurement unit or another type of unit. In another embodiment, the XR latency threshold corresponds to a delay between an action of a user and a computer-implemented response to the user's action. As another example, the XR latency threshold may correspond to the delay between a user action and the time at which a processor associated with a RAN component (e.g., an XR server) receives the user action data. In some embodiments, the XR latency threshold corresponds to an end-to-end latency.

In some embodiments, a URLLC slice may additionally or alternatively be identified based on a jitter measurement (e.g., in milliseconds or microseconds), a communication service availability (e.g., relating to a service interface), a reliability (e.g., relating to a RAN node, the reliability being equal to or higher than the communication service availability), a user experienced data rate (e.g., in Mbps), a payload size (e.g., measured in bytes), a traffic density (e.g., measured in Gbps/km² or Tbps/km²), a packet loss rate, a packet loss ratio, an average throughput, a packet delay, another type of URLLC slice performance measurement, or one or more combinations thereof. In some embodiments, the URLLC slice may be logically independent of a massive machine type communication slice having different network resources (e.g., equipment, access, transmission, or core network).

At 206, the RAN can transmit (e.g., via the user plane function) an XR data packet (e.g., a small XR data packet), via the URLLC slice having the latency parameter below the XR latency threshold, to the user device based on receiving the request and identifying the URLLC slice. In some embodiments, the RAN can also transmit (e.g., via the user plane function) a New Radio Absolute Radio Frequency Channel Number, corresponding to the URLLC slice, to the user device. In some embodiments, the XR data packet and the New Radio Absolute Radio Frequency Channel Number are transmitted simultaneously. In some embodiments, the RAN can also transmit (e.g., via the user plane function) one or more of the jitter measurement, the communication service availability, the reliability, the user experienced data rate, the payload size, the traffic density, the packet loss rate, the packet loss ratio, the average throughput, the packet delay, the other type of URLLC slice performance measurement, or one or more combinations thereof, to the user device.

At 208, the RAN can transmit (e.g., via the user plane function) another XR data packet (e.g., a small XR data packet) via a second URLLC slice to the user device based on the request (or another request). For example, the RAN can transmit the other XR data packet based on identifying the second URLLC slice (e.g., associated with one or more RAN nodes) based on the XR latency threshold (e.g., based on the second URLLC slice having a latency parameter below the XR latency threshold). In some embodiments, the second URLLC slice corresponds to a different frequency band than the frequency band of the other URLLC slice. In other embodiments, the second URLLC slice corresponds to the same frequency band as the frequency band of the other URLLC slice. In some embodiments, the RAN also transmits a New Radio Absolute Radio Frequency Channel Number, corresponding to the second URLLC slice, to the user device. In some embodiments, the RAN also transmits one or more additional URLLC slice performance measurements of the second URLLC slice (e.g., one or more of the jitter measurement, the communication service availability, the reliability, the user experienced data rate, the payload size, loading/congestion, the packet loss rate, the packet loss ratio, the average throughput, the packet delay) to the user device. In some embodiments, the second XR data packet is transmitted via the second URLLC slice based on based on the request and based on the RAN allocating a plurality of XR data packets for transmission over a plurality of URLLC slices.

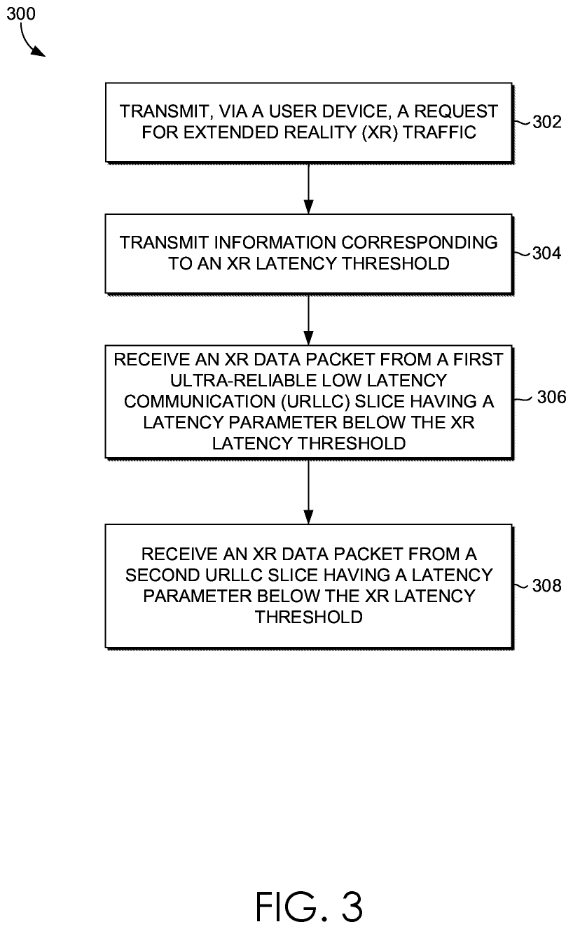

Turning to FIG. 3, example flowchart 300 from the user device perspective begins at 302 with the user device transmitting a request for XR traffic. In some embodiments, the request for XR traffic is transmitted for receipt by the user plane function of the RAN. At 304, the user device transmits an XR latency threshold. In some embodiments, the request includes the XR latency threshold. In some embodiments, the XR latency threshold is transmitted for receipt by the user plane function of the RAN. In some embodiments, the request additionally includes a jitter threshold, a payload size threshold, a reliability threshold, a packet delay threshold, a user experienced data rate threshold, another type of URLLC slice performance threshold, or one or more combinations thereof. At 306, based on the request, the user device receives an XR data packet from a URLLC slice having a latency parameter below the XR latency threshold. At 308, based on the request, the user device receives a second XR data packet from a second URLLC slice having a latency parameter below the XR latency threshold. In some embodiments, the URLLC slice corresponds to a first frequency band and the second URLLC slice corresponds to a second frequency band. In some embodiments, the URLLC slice and the second URLLC slice correspond to a first frequency band. In some embodiments, based on the request, the user device also receives a third XR data packet from a third URLLC slice having a latency parameter below the XR latency threshold.

### Example Satellite

Having described the example embodiments discussed above of the presently disclosed technology, an example operating environment of an example satellite (e.g., satellite 132A, 132B or 132C of FIGS. 1A-1B) is described below with respect to FIG. 4. Example environment 400 is but one example of a suitable satellite environment, and is not intended to suggest any particular limitation as to the scope of use or functionality of the technology disclosed. Neither should example satellite 402 be interpreted as having any dependency or requirement relating to any particular component illustrated, or a particular combination of the components illustrated in FIG. 4.

As illustrated in FIG. 4, example satellite 402 includes antenna(s) 404, transponder(s) 406, power system(s) 408, an orientation and stabilization system 410, sensor(s) 412, database(s) 414, URLLC slice allocator 416, propulsion system 418, and processor(s) 420. The antenna(s) 404 of the satellite 402 can be configured to communicate with user devices, gateways, other satellites, other nodes, or one or more combinations thereof. The antenna(s) 404 may be based on one or more antenna elements (e.g., monopoles or dipoles, loop antennas, helical antennas, patch antennas, inverted-F antennas, Yagi antennas, slot antennas, horn antennas, cavity antennas) and can be used in one or more antenna arrays (e.g., phased antenna arrays, fixed direct radiating arrays, deployable direct radiating antenna arrays, space fed arrays, reflector fed arrays). For example, the antenna(s) 404 can receive signal transmissions from user devices and can communicate location data to the user devices associated with a Satellite Positioning System or Global Navigation Satellite System, concentration data of one or more atmospheric gases detected by the satellite 402, carrier frequency data, ionospheric or tropospheric scintillation loss data detected by satellite 402, a solar activity level detected by one or more sensors 412, an orbit of the satellite 402, or one or more combinations thereof.

Transceiver circuitry of the satellite 402 may include transponder(s) 406 capable of receiving uplink signals and capable of transmitting downlink signals. For example, the transponder(s) 406 may receive, amplify, or retransmit one or more signals between the satellite 402 and a gateway or user device, for example. As another example, one or more of the transponder(s) 406 can operate within a particular frequency band. In some embodiments, the transponder(s) 406 can perform a bent-pipe transmission. In some embodiments, one or more of the transponder(s) 406 can operate in a single-channel per carrier mode, a time-division multiple access mode, another type of mode, or one or more combinations thereof.

The power system(s) 408 can supply power to the satellite 402. For example, the power system(s) 408 may include one or more solar panels, one or more arrays of solar panels, power regulator circuitry, one or more batteries (e.g., silver zinc cell, lithium cell, solar cell), another type of power system component, or one or more combinations thereof. The power system(s) may also store electrical power generated from solar energy. The orientation and stabilization system 410 can act as a stabilizer (e.g., spin stabilization or three-axis (e.g., yaw axis, roll axis, and pitch axis) stabilization). The orientation and stabilization system 410 may also modify or control the spin and rotation of the satellite 402 (e.g., speed of rotation).

The sensor(s) 412 may include a sun sensor for detecting the director or position of the sun, an earth sensor for detecting the direction or position of the earth, light-based sensors (e.g., infrared sensors, visible light sensors, ultraviolet sensors), LIDAR, radar, backscattered light or backscattered radio-frequency signal sensors, temperature sensors, radiation sensors, accelerometers, gyroscopes, magnetic sensors, spectrometers, microwave sensors, particle detectors, another type of sensor, or one or more combinations thereof. The database(s) 514 may include one or more of a telemetry database, a payload database, an orbital database, a command and control database, a mission planning database, a reference database (e.g., for storing celestial data), a ground station database (e.g., for storing data from communications with terrestrial devices), another type of database, or one or more combinations thereof.

In embodiments, URLLC slice allocator 416 can allocate one or more portions of a satellite beam into one or more URLLC slices for one or more XR application services for one or more user devices. In some embodiments including a satellite network with a plurality of satellite network nodes (e.g., satellites other than satellite 402) that each have a moving orbit, the URLLC slice allocator 416 can schedule one or more handovers with another satellite network node. In some embodiments, the URLLC slice allocator 416 can periodically determine that a particular URLLC slice for XR traffic has a latency parameter below an XR latency threshold. In some embodiments, the URLLC slice allocator 416 can identify one or more URLLC slices for XR traffic based on one or more of a location of the user device, one or more capabilities of the user device (e.g., user device antenna capability), a frequency associated with the URLLC slice, one or more latency parameters of the URLLC slice, or one or more combinations thereof. In some embodiments, the satellite 402 can provide one or more home public land mobile networks with prioritization information associated with access to the URLLC slice.

The propulsion system 418 can control the orbit of the satellite 402. For example, the propulsion system 418 can correspond to chemical propulsion, electric propulsion, compressed gas propulsion, hybrid propulsion, another type of propulsion, or one or more combinations thereof. The processor(s) 420 can be utilized by or for one or more of the antenna(s) 404, transponder(s) 406, power system(s) 408, orientation and stabilization system 410, sensor(s) 412, database(s) 414, URLLC slice allocator 416, propulsion system 418, another satellite component, or one or more combinations thereof. For example, the processor(s) 420 can process sensor data and determine the next satellite pass parameter. In an example embodiment, the processor(s) 420 can be a central processing unit, a digital signal processor, a field-programmable gate array, a graphics processing unit, a system-on-chip, a radiation-tolerant processor, another type of processor, or one or more combinations thereof.

### Example User Device

Having described the example embodiments discussed above of the presently disclosed technology, an example operating environment of an example user device (e.g., user device 102A of FIG. 1A) is described below with respect to FIG. 5. User device 500 is but one example of a suitable computing environment, and is not intended to suggest any particular limitation as to the scope of use or functionality of the technology disclosed. Neither should user device 500 be interpreted as having any dependency or requirement relating to any particular component illustrated, or a particular combination of the components illustrated in FIG. 5.

As illustrated in FIG. 5, example user device 500 includes a bus 502 that directly or indirectly couples the following devices: memory 504, one or more processors 506, one or more presentation components 508, one or more input/output (I/O) ports 510, one or more I/O components 512, a power supply 514, and one or more radios 516.

Bus 502 represents what may be one or more busses (such as an address bus, data bus, or combination thereof). Although the various blocks of FIG. 5 are shown with lines for the sake of clarity, in reality, these blocks represent logical, not necessarily actual, components. For example, one may consider a presentation component, such as a display device, to be an I/O component. Also, processors have memory. Accordingly, FIG. 5 is merely illustrative of an exemplary user device that can be used in connection with one or more embodiments of the technology disclosed herein.

User device 500 can include a variety of computer-readable media. Computer-readable media can be any available media that can be accessed by user device 500 and may include both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by user device 500. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. One or more combinations of any of the above should also be included within the scope of computer-readable media.

Memory 504 includes computer storage media in the form of volatile and/or nonvolatile memory. The memory 504 may be removable, non-removable, or a combination thereof. Example hardware devices of memory 504 may include solid-state memory, hard drives, optical-disc drives, other hardware, or one or more combinations thereof. As indicated above, the computer storage media of the memory 504 may include RAM, Dynamic RAM, ROM, EEPROM, flash memory or other memory technology, CD-ROM, a cache memory, DVDs or other optical disk storage, magnetic cassettes, magnetic tape, magnetic disk storage or other magnetic storage devices, a short-term memory unit, a long-term memory unit, any other medium which can be used to store the desired information and which can be accessed by user device 500, or one or more combinations thereof.

The one or more processors 506 of user device 500 can read data from various entities, such as the memory 504 or the I/O component(s) 512. The one or more processors 506 may execute, for example, software to control one or more components of the user device 500. In addition, the one or more processors 506 can execute instructions, for example, of an operating system of the user device 500 or of one or more suitable applications (e.g., XR application 104A of FIG. 1A). Further, the one or more processors 506 may include, for example, one or more microprocessors, one or more CPUs, a digital signal processor, one or more cores, a host processor, a controller, a chip, a microchip, one or more circuits, a logic unit, an integrated circuit, an application-specific integrated circuit, any other suitable multi-purpose or specific processor or controller, or one or more combinations thereof. In some embodiments, the one or more processors 506 may include a main processor (e.g., a central processing unit, an application processor), an auxiliary processor (e.g., a graphics processing unit, an image signal processor, a sensor hub processor, a communication processor) that is operable independently from, or in conjunction with, the main processor, another type of processor, or one or more combinations thereof. Additionally or alternatively, the auxiliary processor may be adapted to consume less power than the main processor. In some embodiments, the auxiliary processor may be specific to a specified function. In some embodiments, the auxiliary processor may be implemented as separate from, or as part of the main processor.

The one or more presentation components 508 can present data indications via user device 500, another user device, or a combination thereof. Example presentation components 508 may include a display device (e.g., adapted to detect a touch), speaker, a hologram component, a printing component, sensor circuitry (e.g., a pressure sensor capable of measuring an intensity of force incurred by a touch), a vibrating component, a projector and control circuitry, another type of presentation component, or one or more combinations thereof. In some embodiments, the one or more presentation components 508 may comprise one or more applications or services on a user device, across a plurality of user devices, or in the cloud. The one or more presentation components 508 can generate user interface features, such as graphics, buttons, sliders, menus, lists, prompts, charts, audio prompts, alerts, vibrations, pop-ups, notification-bar or status-bar items, in-app notifications, other user interface features, or one or more combinations thereof.

The one or more I/O ports 510 allow user device 500 to be logically coupled to other devices, including the one or more I/O components 512, some of which may be built in. Example I/O components 512 can include a microphone, joystick, game pad, satellite dish, scanner, printer, wireless device, and the like. The one or more I/O components 512 may, for example, provide a natural user interface that processes air gestures, voice, or other physiological inputs generated by a user. In some instances, the inputs the user generates may be transmitted to an appropriate network element for further processing. A natural user interface may implement any combination of speech recognition, touch and stylus recognition, facial recognition, biometric recognition, gesture recognition both on screen and adjacent to the screen, air gestures, head and eye tracking, and touch recognition associated with the one or more presentation components 508 on the user device 500.

In some embodiments, the user device 500 may be equipped with one or more imaging devices, such as one or more depth cameras, one or more stereoscopic cameras, one or more infrared cameras, one or more RGB cameras, another type of imaging device, or one or more combinations thereof, (e.g., for gesture detection and recognition). Additionally, the user device 500 may, additionally or alternatively, be equipped with one or more accelerometers, gyroscopes, magnetometers, cameras, capacitance sensors, proximity sensors (e.g., an infrared proximity sensor or a capacitive proximity sensor), an atmospheric pressure sensor, a gesture sensor, a grip sensor, a color sensor, an illuminance sensor, a humidity sensor, another type of sensor, or one or more combinations thereof. In some embodiments, the output of the motion or orientation sensors may be provided to the one or more presentation components 508 of the user device 500 to render immersive augmented reality, virtual reality, another type of extended reality, or one or more combinations thereof.

The power supply 514 of user device 500 may be implemented as one or more batteries or another power source for providing power to components of the user device 500. In embodiments, the power supply 514 can include an external power supply, such as an AC adapter or a powered docking cradle that supplements or recharges the one or more batteries. In aspects, the external power supply can override one or more batteries or another type of power source located within the user device 500.

Some embodiments of user device 500 may include one or more radios 516 (or similar wireless communication components). The one or more radios 516 can transmit, receive, or both transmit and receive signals for wireless communications. In embodiments, the user device 500 may be a wireless terminal adapted to receive communications and media over various wireless networks. User device 500 may communicate using the one or more radios 516 via one or more wireless protocols, such as code division multiple access (“CDMA”), global system for mobiles (“GSM”), time division multiple access (“TDMA”), another type of wireless protocol, or one or more combinations thereof. In embodiments, the wireless communications may include one or more short-range connections (e.g., a Wi-Fi® connection, a Bluetooth connection, a near-field communication connection), a long-range connection (e.g., CDMA, GPRS, GSM, TDMA, 802.16 protocols), or one or more combinations thereof. In some embodiments, the one or more radios 516 may facilitate communication via radio frequency signals, frames, blocks, transmission streams, packets, messages, data items, data, another type of wireless communication, or one or more combinations thereof.

The one or more radios 516 may be capable of transmitting, receiving, or both transmitting and receiving wireless communications via mm waves, FD-MIMO, massive MIMO, 3G, 4G, 5G, 6G, another type of Generation, 802.11 protocols and techniques, another type of wireless communication, or one or more combinations thereof. For example, the one or more radios 516 may be capable of handling wireless communications in frequency ranges such as a low-band communication from 600 to 960 MHz, a mid-band communication from 1710 to 2170 MHz, a high band communication from 2300 to 2700 MHz, an ultra-high band communication from 3400 to 3700 MHz, another communication band between 600 MHz and 4000 MHz, another suitable frequency, or one or more combinations thereof. The one or more radios 516 may also be capable of handling XR data.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software. For instance, various functions may be carried out by a processor executing instructions stored in memory. As such, other arrangements and elements (for example, machines, interfaces, functions, orders, and groupings of functions, and the like) can be used in addition to, or instead of, those shown.

Embodiments of the present disclosure have been described with the intent to be illustrative rather than restrictive. Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A system for improved data transmissions over a radio access network (RAN), the system comprising:
one or more RAN nodes;
one or more processors associated with the one or more RAN nodes; and
computer memory storing computer-usable instructions that, when executed by the one or more processors, cause the system to perform operations comprising:
receiving a request for extended reality (XR) traffic, the request being associated with a user device;
based on the request, identifying a frequency band associated with the one or more RAN nodes, the frequency band having an ultra-reliable low latency communication (URLLC) slice that has a latency parameter below an XR latency threshold; and
transmitting an XR data packet, via the URLLC slice having the latency parameter below the XR latency threshold, to the user device.

2. The system according to claim 1, the operations further comprising:
identifying a second URLLC slice associated with the one or more RAN nodes, wherein the second URLLC slice is identified based on the XR latency threshold; and
transmitting another XR data packet, via the second URLLC slice, to the user device.

3. The system according to claim 2, wherein the second URLLC slice corresponds to a different frequency band.

4. The system according to claim 1, the operations further comprising:
transmitting a New Radio Absolute Radio Frequency Channel Number corresponding to the URLLC slice to the user device.

5. The system according to claim 1, wherein the one or more RAN nodes corresponds to a satellite.

6. The system according to claim 1, wherein the XR data packet is transmitted by a user plane function of the RAN.

7. The system according to claim 6, the operations further comprising:
determining, via a Radio Channel Performance Predictor, a data rate, the latency parameter, and a jitter measurement for the URLLC slice;
communicating the data rate, the latency parameter, and the jitter measurement to the user plane function; and
transmitting the data rate, the latency parameter, and the jitter measurement to the user device via the user plane function.

8. The system according to claim 1, wherein the request includes the XR latency threshold.

9. A method for improved data transmissions over a radio access network (RAN), the method comprising:
receiving, via a RAN node, a request for extended reality (XR) traffic, the request being associated with a user device;
based on the request, allocating a plurality of XR data packets for transmission over one or more ultra-reliable low latency communication (URLLC) slices;
based on the request, identifying a frequency band associated with the RAN node, the frequency band having a URLLC slice, corresponding to the one or more URLLC slices, that has a latency parameter below an XR latency threshold; and
transmitting a first XR data packet, of the plurality of XR data packets, to the user device via the URLLC slice having the latency parameter below the XR latency threshold.

10. The method according to claim 9, wherein the latency parameter is determined by a Radio Channel Performance Predictor including an application corresponding to a RAN intelligent controller.

11. The method according to claim 10, further comprising:
determining, via the Radio Channel Performance Predictor, a data rate corresponding to the URLLC slice; and
transmitting the data rate to the user device.

12. The method according to claim 9, further comprising:
based on the request, identifying a second frequency band, the second frequency band having a second URLLC slice, corresponding to the one or more URLLC slices, that has a latency parameter below the XR latency threshold; and
transmitting a second XR data packet, of the plurality of XR data packets, to the user device via the second URLLC slice having the latency parameter below the XR latency threshold.

13. The method according to claim 12, wherein the second frequency band is associated with a second RAN node.

14. The method according to claim 9, wherein the XR data packet is transmitted by a user plane function of the RAN.

15. The method according to claim 14, further comprising transmitting, via the user plane function, a New Radio Absolute Radio Frequency Channel Number corresponding to the URLLC slice to the user device.

16. One or more non-transitory computer storage media having computer-executable instructions embodied thereon, that when executed by at least one processor, cause the at least one processor to perform a method comprising:
transmitting, via a user device, a request for extended reality (XR) traffic;
based on the request, receiving an XR data packet, from an ultra-reliable low latency communication (URLLC) slice having a latency parameter below an XR latency threshold; and
receiving a second XR data packet from a second URLLC slice having a latency parameter below the XR latency threshold.

17. The one or more non-transitory computer storage media of claim 16, wherein the URLLC slice corresponds to a first frequency band and the second URLLC slice corresponds to a second frequency band.

18. The one or more non-transitory computer storage media of claim 16, wherein the URLLC slice and the second URLLC slice correspond to a first frequency band.

19. The one or more non-transitory computer storage media of claim 16, wherein the XR data packet is received by a user plane function of the RAN.

20. The one or more non-transitory computer storage media of claim 16, further comprising receiving a third XR data packet from a third URLLC slice having a latency parameter below the XR latency threshold, wherein the request includes the XR latency threshold.
